(19) United States
(12) Patent Application Publication
(10) Pub. No.: US 2013/0238748 A1
(43) Pub. Date: Sep. 12, 2013

(54) ELECTRONIC DISTRIBUTION METHOD, ELECTRONIC DISTRIBUTION DEVICE AND ELECTRONIC DISTRIBUTION PROGRAM

(71) Applicants: Hideyoshi Sakahira, Yokohama (JP); Takayo Fujitsuka, Yokohama (JP)

(72) Inventors: Hideyoshi Sakahira, Yokohama (JP); Takayo Fujitsuka, Yokohama (JP)

(73) Assignee: Hitachi, Ltd.

(21) Appl. No.: 13/640,633

(22) PCT Filed: Feb. 15, 2011
(86) PCT No.: PCT/JP2011/053092

§ 371 Date: Dec. 17, 2012

(30) Foreign Application Priority Data
Apr. 14, 2010 (JP) 2010-093183

(51) Int. Cl. H04L 29/08

(52) U.S. Cl. CPC H04L 67/10
USPC 709/217

(57) ABSTRACT

Electronic distribution device for repeatedly distributing content comprising a plurality of content elements to a user terminal device at a predetermined distribution time, comprising a storage unit for storing away view history information for storing, for each content element and for each user, a view count of views of the content by the user; and a control unit for determining a combination of a content element capable of being distributed after a predetermined distribution time and a user, on the basis of the view count of the view history information, and generating and distributing the content element of the determined combination to the user terminal device used by the user of the determined combination, after the distribution time, after receiving a view request for the content element from the user terminal device.

### BACKGROUND

This invention relates to an electronic distribution method, an electronic distribution device, and an electronic distribution program.

Distributing a mail magazine or similar contents to a plurality of users via a computer has been practiced. From the viewpoint of making the most of computer resources, a technology has been disclosed which narrows contents to be distributed down to ones that are highly likely to be viewed. Patent Document 1, for example, discloses as means to distribute articles desired by a user without omission a technology that involves distributing articles in two stages and monitoring the viewing state of an article distributed in the first distribution so that an undistributed article correlated to the viewed article is picked as an article to be distributed in the second distribution.
Patent Document 1: Japanese Patent Application Laid-open No. 2006-252067 (paragraph 0006)

### SUMMARY

However, the invention of Patent Document 1 does not include a mechanism that allows a user to easily view, after the fact, contents that are regarded as a mismatch to the needs of the user and therefore have not been distributed to the user.

For example, in the case of the generation of pay statements or other contents that must be distributed by a certain point in time, many users tend to view important contents elements (such as a page where the pay total is written) immediately after distribution and view contents elements of low importance at a later point. The invention of Patent Document 1 does not disclose a measure for dealing with a case where a user wishes to view the contents elements of low importance. Preparing many computer resources at a cost in order to distribute all contents elements from the beginning generates surplus resources in other times than the peak of distribution. On the other hand, reducing contents elements that are distributed degrades the quality of the contents. The invention of Patent Document 1 is not equipped to economize computer resources while maintaining contents quality in such cases.

It is therefore an object of this invention to economize computer resources necessary to generate contents, while maintaining contents quality, by avoiding the temporal concentration of computer processing when a computer is to send the same type of contents repeatedly to users.

An electronic distribution device according to this invention is an electronic distribution device for repeatedly distributing contents including a plurality of contents elements at a predetermined distribution time to user terminal devices used by users of the contents. The electronic distribution device includes: storage for storing view history information which stores, for each of the plurality of contents elements and for each of the users, a view count indicating how many times the each of the users has viewed the contents; and a controller configured to determine a combination of one of the plurality of contents elements that can be distributed past the predetermined distribution time and one of the users based on the view count of the view history information, and generate and distribute the contents element of the determined combination to a user terminal device used by the user of the determined combination, at a point that is after the predetermined distribution time and after a request to view the contents element is received from the user terminal device. Other means are described in the detailed description of the embodiments.

According to this invention, computer resources necessary to generate contents are economized, while maintaining contents quality, by avoiding the temporal concentration of computer processing when a computer is to send the same type of contents repeatedly to users.

### BRIEF DESCRIPTION OF THE DRAWINGS

FIG. 1(a) is a conceptual diagram of an existing technology prior to the application of an embodiment of this invention. FIG. 1(b) is a conceptual diagram of the embodiment.

FIG. 2 is a configuration diagram of an electronic distribution system according to the embodiment.

FIGS. 3(a), 3(b), and 3(c) are diagrams illustrating an example of pre-generation data according to the embodiment.

FIG. 4(a) is a diagram illustrating an example of a pre-generation target table according to the embodiment. FIGS. 4(b) and 4(c) are diagrams illustrating an example of a view history table according to the embodiment.

FIGS. 5(a), 5(b), and 5(c) are diagrams illustrating an example of a viewed time table according to the embodiment.

FIG. 6(a) is a diagram illustrating an example of a generation method table according to the embodiment. FIG. 6(b) is a diagram illustrating an example of a generation order table according to the embodiment. FIG. 6(c) is a diagram illustrating an example of a viewing tendency table according to the embodiment.

FIGS. 7(a), 7(b), and 7(c) are diagrams illustrating an example of a pay statement according to the embodiment.

FIG. 8 is an example of displaying a pay statement according to the embodiment.

FIG. 9 is another example of displaying a pay statement according to the embodiment.

FIG. 10 is a flow chart of a first processing procedure according to the embodiment.

FIG. 11 is a flow chart detailing Step S401 of the first processing procedure according to the embodiment.

FIG. 12 is a flow chart detailing Step S402 of the first processing procedure according to the embodiment.

FIG. 13 is a flow chart of a second processing procedure according to the embodiment.

FIG. 14 is a flow chart detailing Step S502 of the second processing procedure according to the embodiment.

FIG. 15 is a flow chart of a third processing procedure according to the embodiment.

### DETAILED DESCRIPTION OF THE EMBODIMENTS

A mode of carrying out this invention (referred to as “this embodiment”) is described below in detail with reference to the drawings and others. Specifically, an example is described in which a division of a business organization distributes pay statements (which correspond to “contents” described above) to employees of the business organization.

(The Concept of This Embodiment)

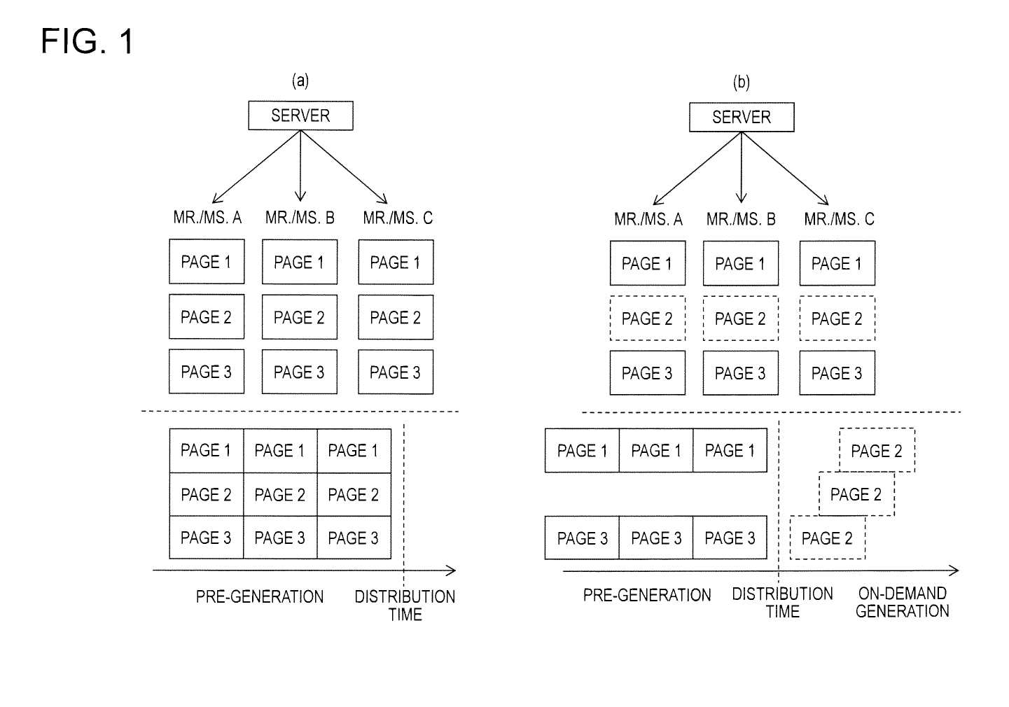

FIG. 1(a) is a conceptual diagram of an existing technology prior to the application of this embodiment.

Mr./Ms. A, Mr./Ms. B, and Mr./Ms. C are employees of a business organization, and a server run by the business organization distributes pay statements once a month to user terminal devices which are used by those employees. After the distribution is executed, the employees can view their respective pay statements at will. Each pay statement is constituted of three pages. In this embodiment, the respective pages correspond to “contents elements” described above. A contents element only needs to be a part of contents that is distinguishable from other parts, and is not limited to a page. A contents element may also include audio data, image data, and the like in addition to text data.

The premise here is that the server needs to distribute all pages of a pay statement to every employee at a predetermined distribution time (for example, 10:00 a.m. on the first of every month). Accordingly, the server executes processing of generating as pay statements three pages multiplied by the employee count (nine pages in this example) by the distribution time (“pre-generation”), and distributing all of the pages at once at the distribution time. This is not a problem in the case where every employee views all pages of his/her pay statement immediately after the distribution. In the case where the employees tend to delay viewing pages that are, for example, less important, on the other hand, there is no need to generate all pages by the distribution time and distribute the pages at the distribution time. Rather, pushing back the time of generation and distribution of some pages is conducive to effective utilization of server resources and the leveling of processing load.

Pushing back the time of generation and distribution of a part of data has merit not only in the example of pay statements but also in other general cases where processing data into a form suitable for viewing and distributing the processed data takes a lot of labor and costs money. For example, in the case of distributing a mail magazine that contains advertisements about products of a plurality of categories to customers, it is often true that a customer frequently views advertisements about products of one category while hardly viewing advertisements about products of other categories. There is a need for a way to avoid expending labor and cost (the original data is purchased from outside in some cases) on the generation of advertisements that are unlikely to be viewed, and further distributing such advertisements as a moving image or other types of data that are large in the amount of information.

FIG. 1(b) is a conceptual diagram of this embodiment.

Here, it is empirically known that “page 2”, for example, of a pay statement is of relatively low importance to users who are the employees and remains unviewed for a while after the distribution. In this case, the server generates only page 1 and page 3 prior to the distribution time, and distribute pay statements that do not contain information of “page 2” at the distribution time. The server generates “page 2” at the time viewing requests are received individually from users (“on-demand generation”), and distributes the generated information. In extreme cases, some users do not view “page 2” at all. It is technically possible in such cases to end up not distributing “page 2” to those users (although, generally, a pay statement should always be delivered in its entirety).

(Electronic Distribution System)

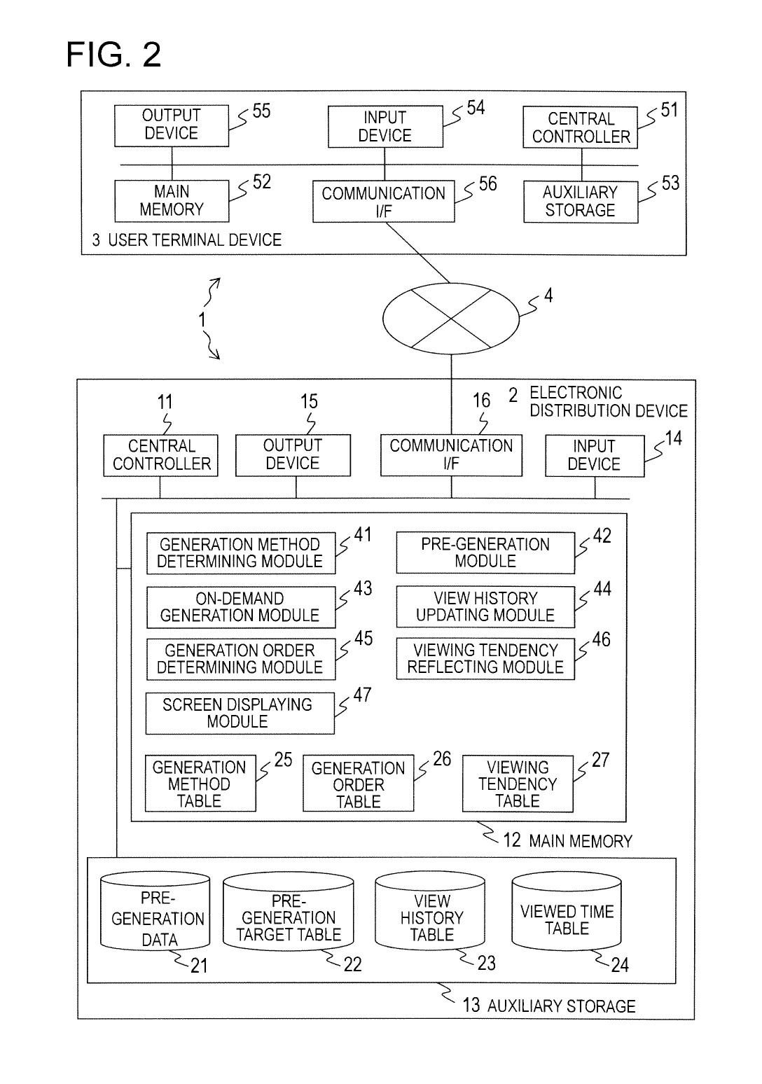

An electronic distribution system 1 is described with reference to FIG. 2.

The electronic distribution system 1 includes an electronic distribution device 2 and a user terminal device 3, which can communicate to/from each other over a network 4.

(Electronic Distribution Device)

The electronic distribution device 2 is a general computer. The electronic distribution device 2 includes a central controller 11, a main memory 12, auxiliary storage 13, an input device 14, an output device 15, and a communication interface (IF) 16, which are connected to one another via a bus.

The auxiliary storage 13 stores pre-generation data 21, a pre-generation target table 22, a view history table 23, and a viewed time table 24 (details are described later). The view history table 23 and the viewed time table 24 correspond to “view history information” and “viewed time information”, respectively.

The main memory 12 stores a generation method determining module 41, a pre-generation module 42, an on-demand generation module 43, a view history updating module 44, a generation order determining module 45, a viewing tendency reflecting module 46, and a screen displaying module 47, which are programs. In the following description, a sentence having “∘∘ module” as the subject means that the central controller 11 reads a relevant program out of the auxiliary storage 13, loads the program onto the main memory 12, and executes the function of the program (details are described later).

The main memory 12 also stores a generation method table 25, a generation order table 26, and a viewing tendency table 27. These are created based on the respective tables stored in the auxiliary storage 13 and the like in the process of executing the respective programs described above, and are stored temporarily (details are described later).

(User Terminal Device)

The user terminal device 3, too, is a general computer. The user terminal device 3 includes a central controller 51, a main memory 52, auxiliary storage 53, an input device 54, an output device 55, and a communication interface (IF) 56, which are connected to one another via a bus.

A plurality of user terminal devices 3 is usually set up near users of the electronic distribution system 1, and the electronic distribution device 2 can be accessed from any of the user terminal devices 3. Typically, one user terminal device is allocated per user who is an employee. One electronic distribution device 2 is usually set up near an administrator of the electronic distribution system 1. The electronic distribution device 2 may be constituted of a plurality of separate components by, for example, putting the auxiliary storage 13 in a different casing. The electronic distribution device 2 may also double as the user terminal device 3.

(Pre-Generation Data)

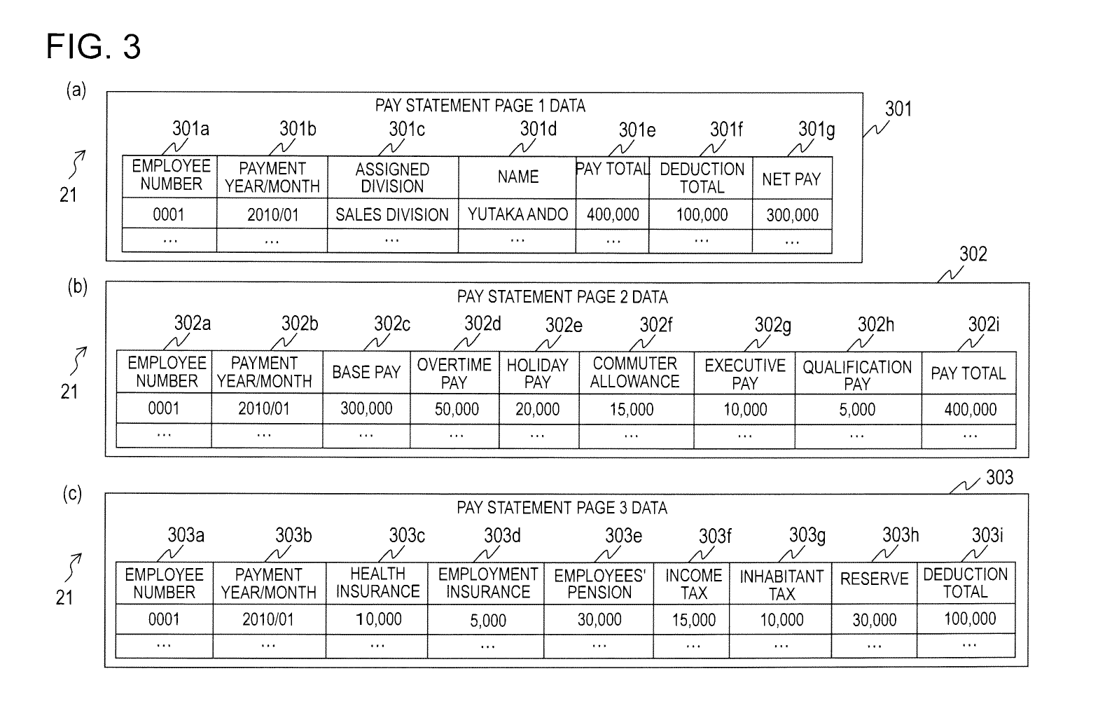

The pre-generation data 21 is described with reference to FIGS. 3(a), 3(b), and 3(c).

Pre-generation data is data to be written in a pay statement that is stored in a database on a page-by-page basis, and is divided into “pay statement page 1 data” 301 (FIG. 3(a)), pay statement page 2 data 302 (FIG. 3(b)), and “pay statement page 3 data” 303 (FIG. 3(c)).

In the “pay statement page 1 data” 301, a payment year/month column 301b stores a payment year/month, an assigned division column 301c stores a name of an assigned division, a name column 301d stores a name, a pay total column 301e stores a pay total, a deduction total column 301f stores a deduction total, and a net pay column 301g stores net pay in association with an employee number stored in an employee number column 301a.

An employee number in the employee number column 310a is an identifier for uniquely identifying an employee.

A payment year/month in the payment year/month column 301b is the year and the month when the employee is paid.

A name of an assigned division in the assigned division column 301c is the name of a division to which the employee belongs.

A name in the name column 301d is the name of the employee.

A pay total in the pay total column 301e is the total amount paid to the employee.

A deduction total in the deduction total column 301f is an amount deducted from the pay total.

Net pay in the net pay column 301g is an amount calculated by subtracting the deduction total from the pay total.

In the “pay statement page 2 data” 302, a payment year/month column 302b stores a payment year/month, columns 302c to 302h each store the amount of an item that is the heading of the column, and a pay total column 302i stores a pay total in association with an employee number stored in an employee number column 302a.

The employee number column 302a and the payment year/month column 302b are as described in the description of the “pay statement page 1 data” 301.

The amount of base pay and other amounts in the base pay column 302c to the qualification pay column 302h are items of the pay total, and the sum of those amounts matches the pay total.

A pay total in the pay total column 302i is the total amount paid to the employee as described above.

In the “pay statement page 3 data” 303, a payment year/month column 303b stores a payment year/month, columns 303c to 303h each store the amount of an item that is the heading of the column, and a deduction total column 303i stores a deduction total in association with an employee number stored in an employee number column 303a.

The employee number column 303a and the payment year/month column 303b are as described in the description of the “pay statement page 1 data” 301.

The amount of health insurance and other amounts in the health insurance column 303c to the reserve column 303h are items of the deduction total, and the sum of those amounts matches the deduction total.

A deduction total in the deduction total column 303i is the amount deducted from the pay total as described above.

The pre-generation data 21 in this embodiment can have any structure as long as data to be written in a pay statement is identifiable on a page-by-page basis, on an employee-by-employee basis, and on a payment year/month-by-payment year/month basis.

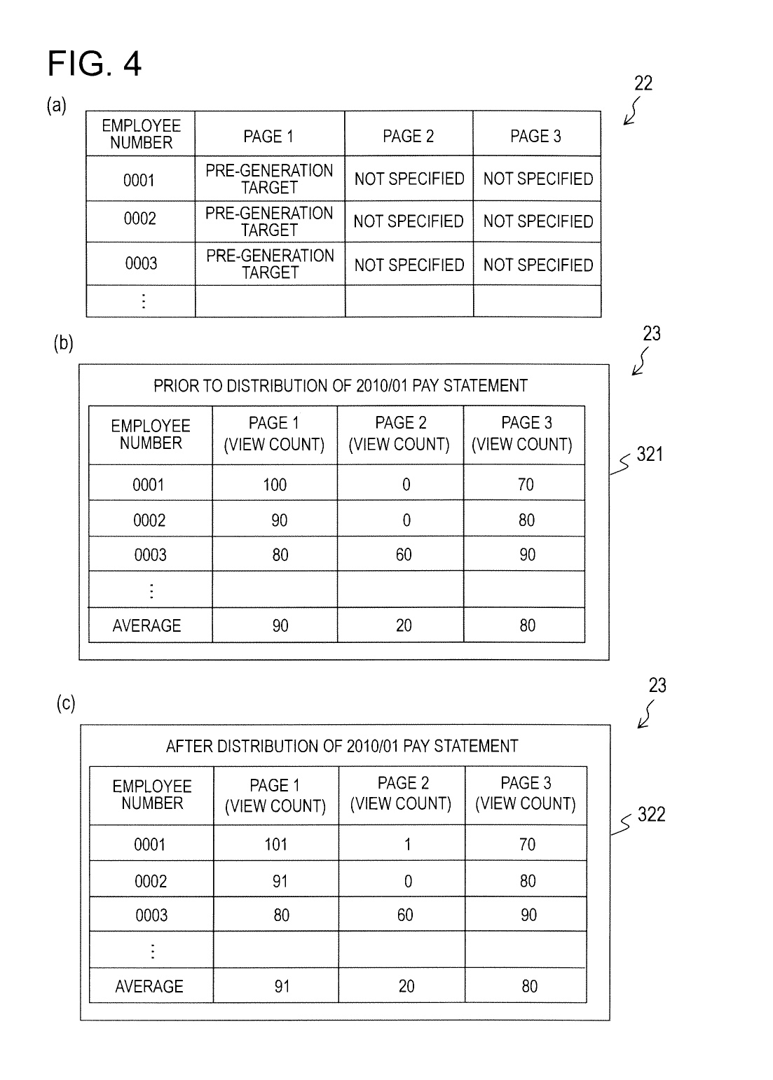

The pre-generation target table 22 is described with reference to FIG. 4(a).

The pre-generation target table 22 is a matrix that has employee numbers on the vertical axis and page numbers on the horizontal axis, and stores a pre-generation necessity flag in cells at the intersections between the vertical axis and the horizontal axis. The pre-generation necessity flag has one of values “pre-generation target” and “not specified”. The value “pre-generation target” indicates that delivering information of the page in question for the employee in question to the employee in question at given due date is contractually or legally imperative. The value “not specified” indicates that there is no such legal necessity, and that the distribution can be pushed back to a date after the given due date at the discretion of the administrator of the electronic distribution system 1.

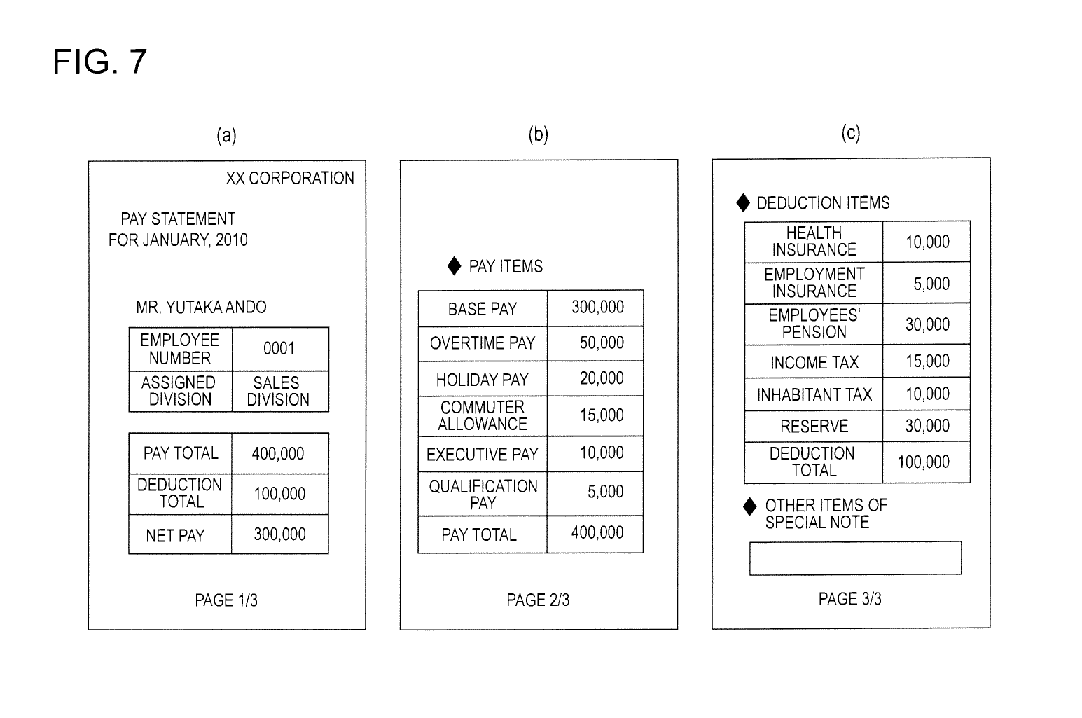

For instance, “page 1” is a “pre-generation target” for employees whose employee numbers are “0001”, “0002”, and “0003”. This means that particularly important items such as the name of the employee and the pay total are written on “page 1” of each pay statement (FIG. 7(a)), and that this page must be generated by a predetermined distribution time and distributed at the distribution time without fail.

The example of FIG. 4(a) where “page 1” is a “pre-generation target” for every employee is just an example. For instance, in the case where there are two types of employees, regular employees and temporary employees, and pay statements of temporary employees include on “page 3” mandatory distribution items specified in a contract with an employment agency, “page 3” may be a “pre-generation target” for specific (temporary) employees whereas “not specified” is set with respect to “page 3” for the rest of the employees.

The pre-generation target table 22 is created for each document type when there are a plurality of document types. This embodiment describes an example in which the only document that the electronic distribution system 1 generates and distributes is “pay statement”. Accordingly, there is only one pre-generation target table 22 here.

(View History Table)

The view history table 23 is described with reference to FIGS. 4(b) and 4(c).

The view history table 23 is a matrix that has employee numbers on the vertical axis and page numbers on the horizontal axis, and stores view counts in cells at the intersections between the vertical axis and the horizontal axis. The view count of an employee in question who is a user is the cumulative number of times the employee has viewed a page in question in a pay statement of each month via the output device 55 of the user terminal device 3 up to the current time. The view count is updated in real time (details are described later).

FIG. 4(b) illustrates a state “prior to distribution of 2010/01 pay statement” 321, which is the state of the view history table 23 immediately before pay statements for January, 2010 are distributed. The first row shows that an employee whose employee number is “0001” has viewed “page 1” “100” times. This count does not mean that the employee “0001” has viewed “page 1” of the “2010/01 pay statement” a hundred times. Instead, this count means that the number of times the employee “0001” has viewed “page 1” of the past pay statements since the time he/she started working for the business organization till today adds up to a hundred times. A user who is an employee may sometimes view a pay statement of the same month more than once. In this case, the system may be configured so as not to count the second and subsequent viewings into the view count (details are described later).

The first row from the bottom stores the average values of view counts stored in the respective columns.

FIG. 4(c) illustrates a state “after distribution of 2010/01 pay statement” 322, which is the state of the view history table 23 immediately after pay statements for January, 2010 are distributed. Compared to the state “prior to distribution of 2010/01 pay statement” 321, view counts stored in cells where the employee “0001” intersects with “page 1” and “page 2”, and a view count stored in a cell where the employee “0002” intersects with “page 1” are each larger by “1”. This indicates that the employee “0001”, for example, has viewed “page 1” and “page 2” of his/her pay statement immediately after the distribution of the pay statement for January, 2010 (“page 1” and “page 2” viewed at the time may be those of a pay statement from several months back, but the possibility is strong that the viewed “page 1” and “page 2” are those of the 2010/01 pay statement which has just been distributed).

The view history table 23 is created for each document type when there are a plurality of document types. In this embodiment, the only document that the electronic distribution system 1 generates and distributes is “pay statement”. Accordingly, there is only one view history table 23 here.

(Viewed Time Table)

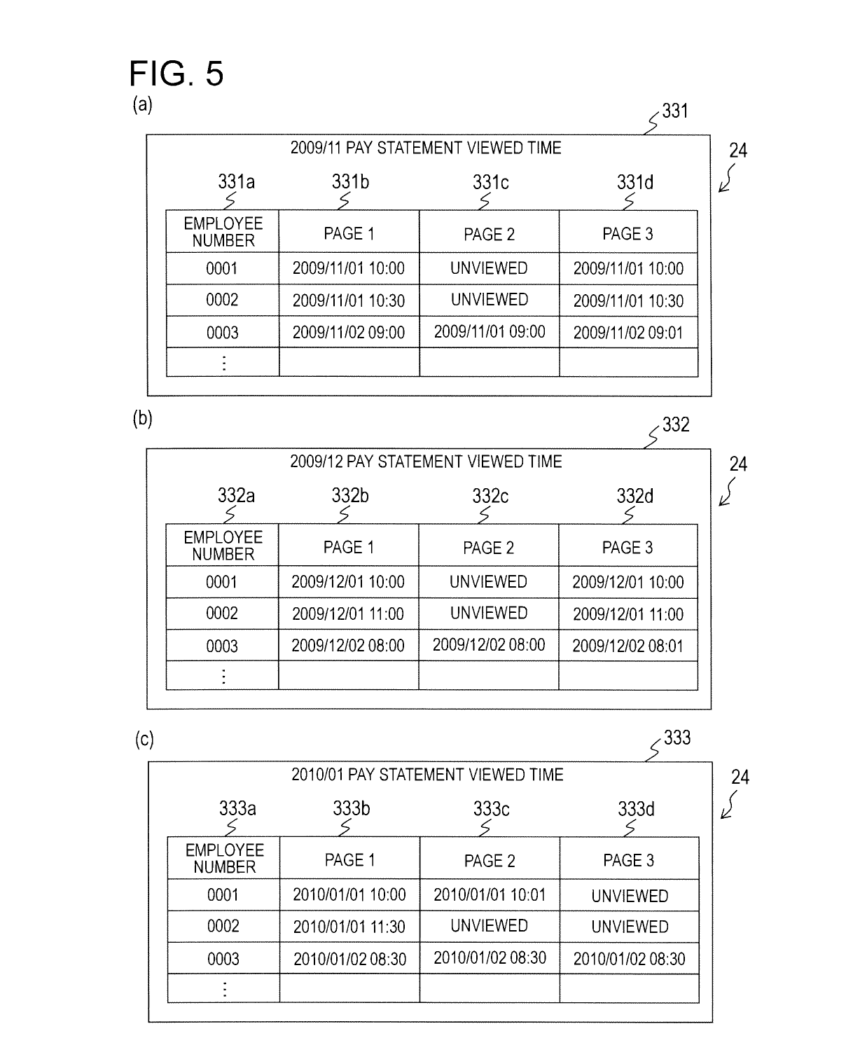

The viewed time table 24 is described with reference to FIGS. 5(a), 5(b), and 5(c).

The viewed time table 24 is a matrix that has employee numbers on the vertical axis and page numbers on the horizontal axis, and stores viewed times in cells at the intersections between the vertical axis and the horizontal axis. The viewed time of an employee in question who is a user is a year/month/day/hour/minute at which the employee has viewed a page in question for the first time up to the current time in a pay statement of each month via the output device 55 of the user terminal device 3.

The viewed time table 24 is created each time pay statements of a month in question are distributed, and there are as many viewed time tables 24 as the number of past months. In the case where an employee in question who is a user has not viewed a page yet, a letter string “unviewed” is stored as the viewed time.

The first row of a “2009/11 pay statement viewed time” 331 shows that the employee “0001” has viewed page 1 of a pay statement for November, 2009 at “2009/11/01 10:00”, has viewed page 3 at “2009/11/01 10:00”, and has not viewed page 2 yet. The viewed time table 24 does not show whether or not the employee “0001” has since viewed page 1 and page 3 of the 2009/11 pay statement.

(Generation Method Table)

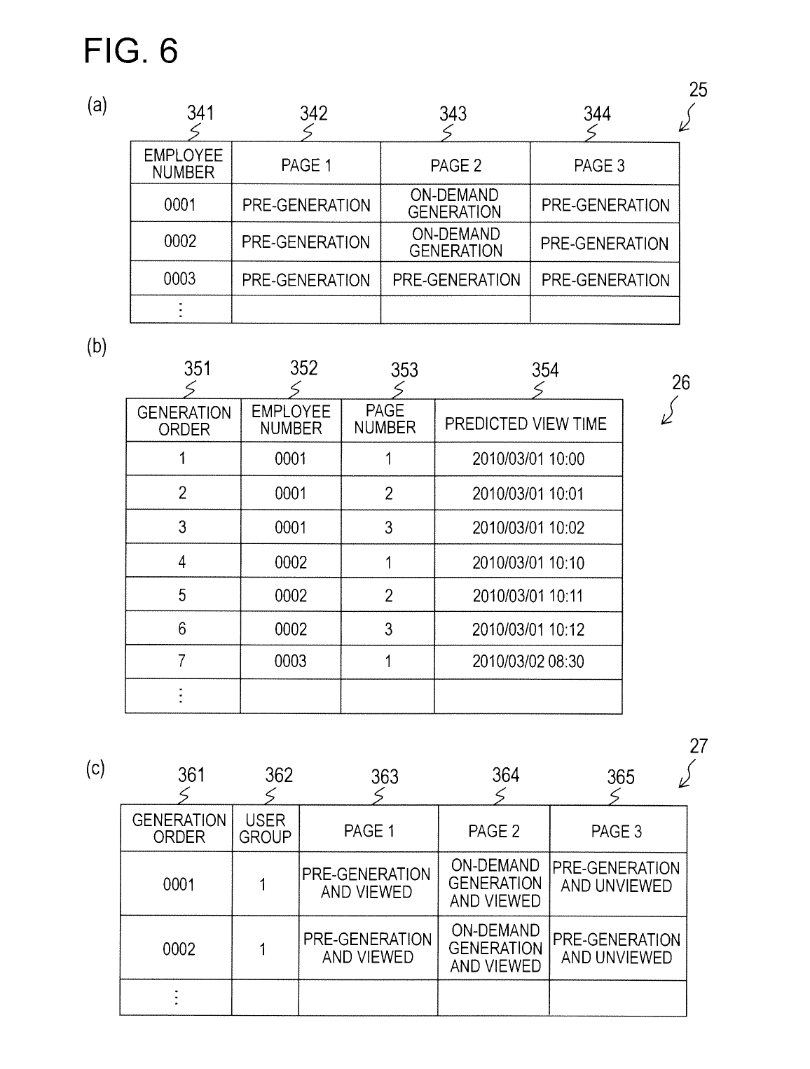

The generation method table 25 is described with reference to FIG. 6(a).

The generation method table 25 is a matrix that has employee numbers on the vertical axis and page numbers on the horizontal axis, and stores a generation method flag in cells at the intersections between the vertical axis and the horizontal axis. The generation method flag has one of values “pre-generation” and “on-demand generation”. The value “pre-generation” indicates that, in the flow of the generation, distribution, and viewing of a page in a specific month (hereinafter may also be referred to as “distribution occasion”), a page in question for an employee in question needs to be generated prior to the distribution time. The value “on-demand generation” indicates that a page in question is generated for the first time when an employee in question makes a viewing request after a pay statement (distributed without information of the page) is distributed to this employee (details are described later).

A comparison between the generation method table 25 of FIG. 6(a) and the pre-generation target table 22 of FIG. 4(a) reveals that each cell storing “not specified” in FIG. 4(a) stores one of “pre-generation” and “on-demand generation” in FIG. 6(a). This indicates that in a distribution occasion, one of “pre-generation” and “on-demand generation” has been determined as the generation method for the page in question for the employee in question. The basis of this determination is, for example, the view count (details are described later). In other words, the generation method flag can take a different value selected from “pre-generation” and “on-demand generation” for a different distribution occasion.

Each cell storing “pre-generation target” in FIG. 4(a) stores “pre-generation” in FIG. 6(a). This indicates that the page in question for the employee in question needs to be generated prior to the distribution time no matter what the distribution occasion.

The generation method table 25 is created for each document type when there are a plurality of document types. In this embodiment, the only document that the electronic distribution system 1 generates and distributes is “pay statement”. Accordingly, there is only one generation method table 25 here.

(Generation Order Table)

The generation order table 26 is described with reference to FIG. 6(b). The generation order table 26 stores an employee number in an employee number column 352, a page number in a page number column 353, and a predicted view time in a predicted view time column 354 in association with a place in generation order stored in a generation order column 351.

Generation order values in the generation order column 351 is the order in which the electronic distribution device 2 generates contents elements (pages of pay statements) in a specific distribution occasion.

Employee numbers in the employee number column 353 are the same as the employee numbers of FIG. 3.

Page numbers in the page number column 353 are page numbers of pay statements.

A predicted view time in the predicted view time column 354 is a time at which an employee in question is predicted to view a page in question in a specific distribution occasion, and is determined based on, for example, past viewed times stored in the viewed time table 24 (details are described later).

The generation order table 26 has as many records as the number of combinations of an employee number and a page number, and one predicted view time is defined for each combination. All records are sorted in chronological order of the predicted view times, and places in generation order are assigned in that order (details are described later).

(Viewing Tendency Table)

The viewing tendency table 27 is described with reference to FIG. 6(c).

The viewing tendency table 27 stores a user group in a user group column 362 and combinations of a generation method flag value and a viewing result in pages that are the headings of a page 1 column 363 to a page 3 column 365, in association with an employee number stored in an employee number column 361.

Employee numbers in the employee number column 361 are the same as the employee numbers of FIG. 3.

User groups in the user group column 362 are the group numbers (1, 2, 3 . . . ) of a plurality of groups into which employees are classified based on the generation order and/or predicted view times.

The page 1 column 363 to the page 3 column 365 each have a value that is a combination of a generation method flag value (the upper part) and a viewing result (the lower part). The generation method flag here is the same as the generation method flag of FIG. 6(a). A viewing result is one of “viewed”, which indicates that a page has been viewed immediately after a specific distribution occasion and “unviewed” which indicates that the page has not been viewed. In the view history table 23 (FIGS. 4(b) and 4(c)), a change in view count between the state “prior to distribution of 2010/01 pay statement” 321 and the state “after distribution of 2010/01 pay statement” 322 is equivalent to “viewed”, and no change between the two is equivalent to “unviewed” (details are described later).

The combinations have three types, specifically, “pre-generation and viewed”, “on-demand generation and viewed”, and “pre-generation and unviewed”. A combination “on-demand generation and unviewed” does not exist because “on-demand generation” is executed for the first time when a viewing request is made.

The combination “pre-generation and unviewed” means that a page in question has been generated prior to the distribution time and distributed at the distribution time to an employee in question, but the employee has not viewed the page, and calls for re-examination about changing to “on-demand generation” in the next distribution occasion. The combination “on-demand generation and viewed”, on the other hand, calls for re-examination about changing to “pre-generation” in the next distribution occasion.

(Processing Procedures)

Processing procedures are described below. The processing procedures include a first processing procedure, a second processing procedure, and a third processing procedure. Features of the respective processing procedures are summarized as follows. The first processing procedure is the basic model in which pages that are low in view count are generated on demand. The second processing procedure involves generating pages in an order that is determined by past viewed times, and distributing pay statements even when a page has not been generated at the distribution time. The third processing procedure involves distributing pay statements to groups of employees who tend to view immediately, re-examining the generation method flag based on the actual viewing state, and then distributing pay statements to remaining groups accordingly. The time to execute any one of the procedures is when a distribution occasion arises.

(First Processing Procedure)

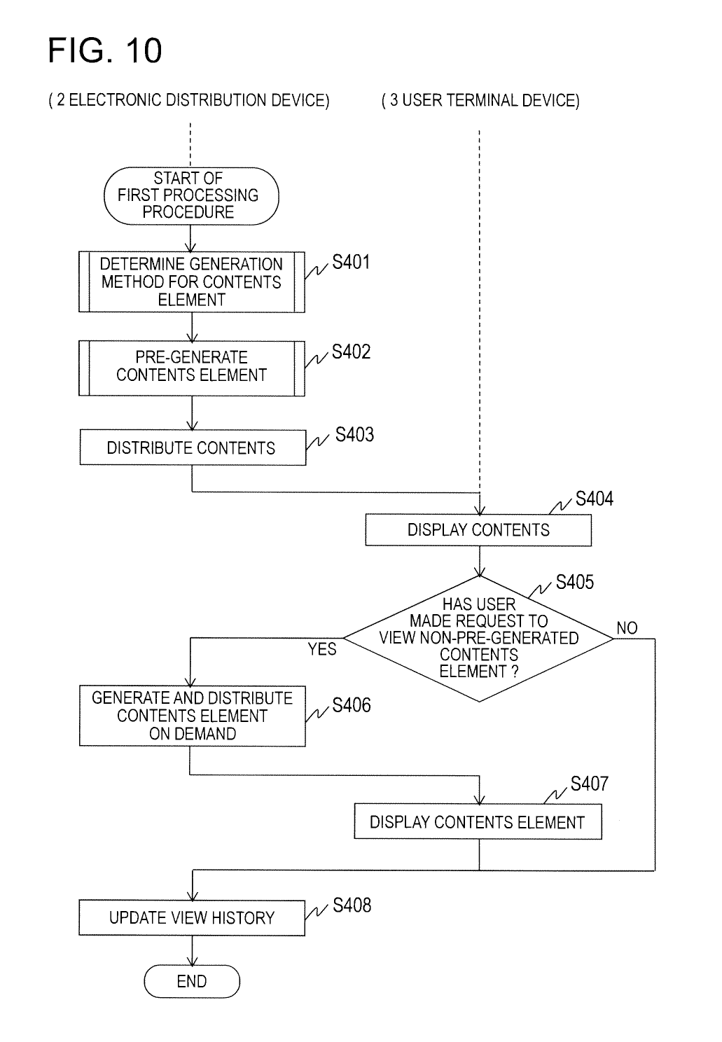

The first processing procedure is described with reference to FIG. 10.

In Step S401, the generation method determining module 41 determines a generation method for a contents element. Specifically, the generation method determining module 41 determines, for each employee and for each page, whether the generation method flag is “pre-generation” or “on-demand generation”. Details of Step S401 are described later.

In Step S402, the pre-generation module 42 pre-generates contents elements. Specifically, the pre-generation module 42 generates pay statement pages that are to be distributed at the distribution time from the pre-generation data 21. Details of Step S402 are described later.

In Step S403, the pre-generation module 42 distributes the contents. Specifically, the pre-generation module 42 distributes to the user terminal device 3 a pay statement that includes pre-generated pages and pages that have not been pre-generated. Of the distributed pay statement pages, a page whose generation method flag is “on-demand generation” holds no information (hereinafter may also be referred to as “blank” page). The electronic distribution device 2 stores a table that stores an association relation between the employee number of an employee and the IP address of the user terminal device 3 that is used by the employee, and is capable of identifying the user terminal device 3 that is the destination of a specific pay statement (the same is true in other processing procedures).

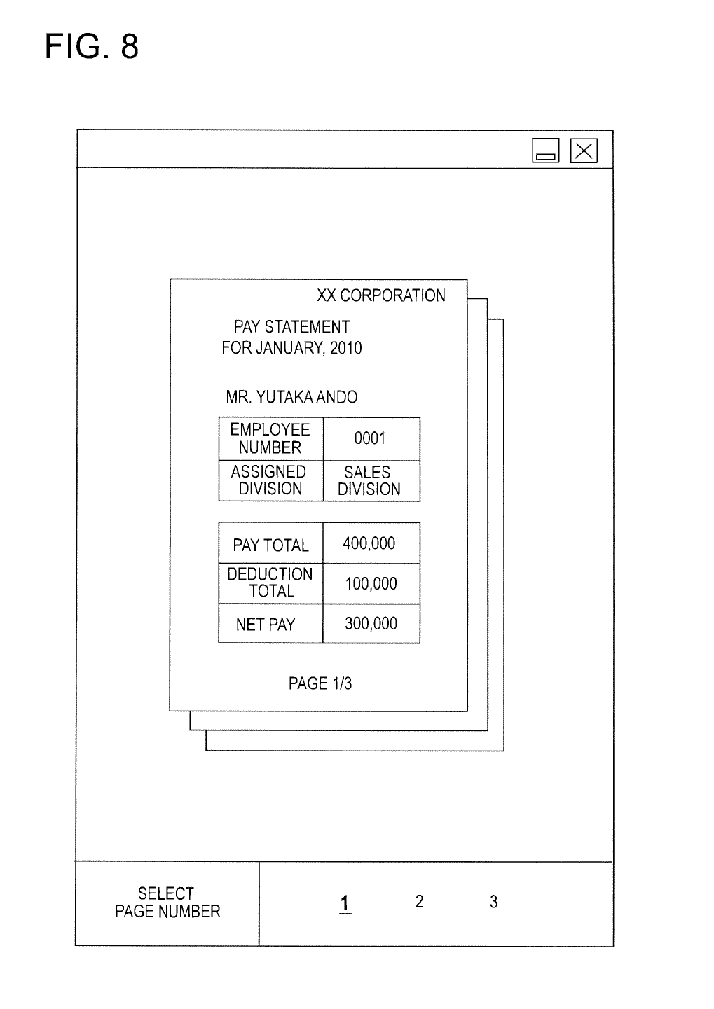

In Step S404, the screen displaying module 47 displays the contents. Specifically, the screen displaying module 47 displays the pay statement distributed in Step S403 on the output device 55 of the user terminal device 3 as illustrated in FIG. 8. The screen displaying module 47 displays the pay statement only when it is confirmed that a combination of an employee number and a password that are received via the input device 54 matches a combination registered in advance in the auxiliary storage 13, and the received employee number matches the employee number of the distributed pay statement (the same is true in other processing procedures).

A pay statement is constituted of three pages as illustrated in FIGS. 7(a), 7(b), and 7(c). These pages, however, may include a “blank” page which holds no information. Accordingly, a page having the lowest page number (a top page) of the pages whose information has been pre-generated is displayed up front, and the other pages are stacked under the top page so that information written on the pages are hidden from view (see FIG. 8, the same is true in other processing procedures).

In Step S405, the screen displaying module 47 determines whether or not a request has been made to view a contents element that has not been pre-generated.

Specifically, the screen displaying module 47 executes a first sub-step to receive, via the input device 54 of the user terminal device 3, an input of the page number of a page that the user who is an employee wishes to view. The user uses the input device 54 which includes a mouse or the like to select one of “1”, “2”, and “3” written in a “select page number” column of FIG. 8.

The screen displaying module 47 executes a second sub-step to store, in the main memory 12, temporarily, the current time in association with the selected page number and the employee number.

The screen displaying module 47 executes a third sub-step to determine whether or not the page of the selected page number is included in the pay statement distributed in Step S403. When the page is included (“NO” in Step S405), the screen displaying module 47 displays the page on the output device 55 of the user terminal device 3 and proceeds to Step S408. Otherwise (“YES” in Step S405), the screen displaying module 47 transmits the selected page number to the electronic distribution device 2, and proceeds to Step S406.

In Step S406, the on-demand generation module 43 generates a contents element on demand and distributes the contents element. Specifically, the on-demand generation module 43 executes a first sub-step to obtain data of the page in question from the pre-generation data 21 (FIG. 3) based on the page number received in Step S405, and generates the page from the obtained data. The on-demand generation module 43 is capable of identifying an employee number from the IP address of the user terminal device 3 that is the sender of the page number, identifying a payment year/month from the current time, and identifying data necessary to generate the page that is requested in the viewing request as a result of searching the pre-generation data 21 (the same is true in other processing procedures).

The on-demand generation module 43 executes a second sub-step to distribute the generated page to the user terminal device 3. During the time from the selection of a page number to the displaying of the information of the page, a message such as “please wait” or “under construction” may be displayed on the page.

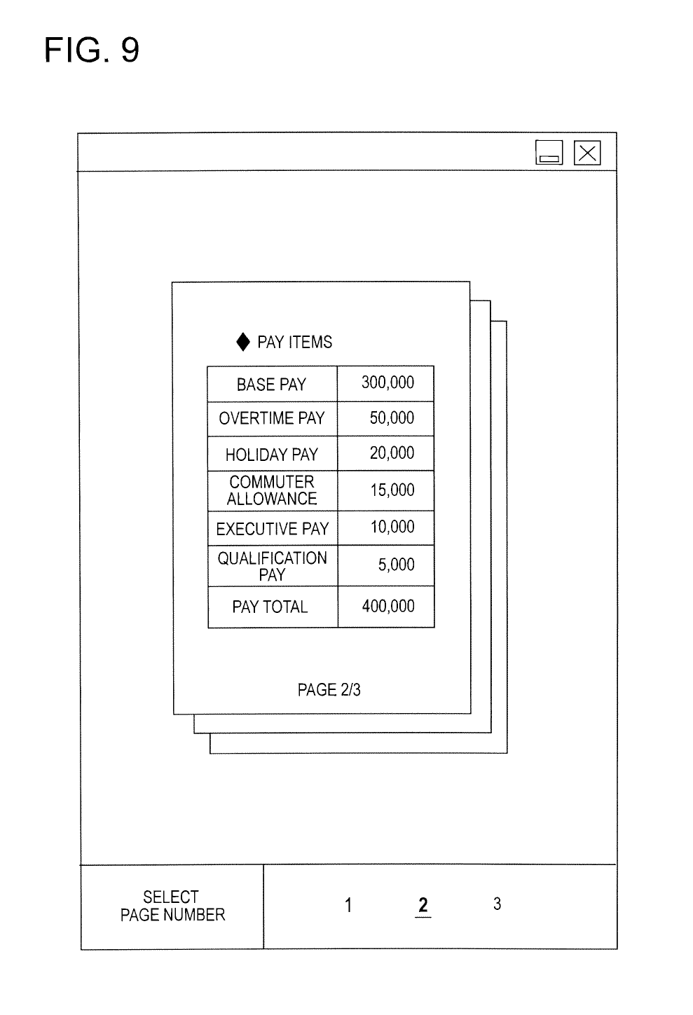

In Step S407, the screen displaying module 47 displays the contents element generated on demand. Specifically, the screen displaying module 47 displays the page generated in Step S406 on the output device 55 of the user terminal device 3. For example, in the case where the selected page number is “2”, page 2 is displayed as the top page as in FIG. 9.

In Step S408, the view history updating module 44 updates the view history. Specifically, the view history updating module 44 executes a first sub-step to generate a new record for the month in question in the viewed time table 24 (FIG. 5). For example, in the case where a pay statement for January, 2010 has been distributed, a record for the “2010/01 pay statement viewed time” 333 is created.

The view history updating module 44 executes a second sub-step to store, in the employee number column (e.g., the column 333a) of the created record, the employee number that has temporarily been stored in the second sub-step of Step S405.

The view history updating module 44 executes a third sub-step to store, in one of columns (e.g., the columns 333b to 333d) of the created record whose headings matches the page number temporarily stored in the second sub-step of Step S405, the current time temporarily stored in the second sub-step of S405.

The view history updating module 44 executes a fourth sub-step to rewrite a cell of the view history table 23 (FIGS. 4(b) and 4(c)) where the employee number on the vertical axis that has temporarily been stored in the second sub-step of Step S405 intersects with the page number on the horizontal axis that has temporarily been stored in the second sub-step of Step S405 by adding “1” to the view count of the cell.

Described above is an example in which a page of a pay statement for a month in question is viewed for the first time. In the case where other pages of the pay statement for the month are viewed subsequently, the first sub-step and the second sub-step are omitted, and the third sub-step and the fourth sub-step are executed for an existing record for the month that has the employee number in question in the employee number column (e.g., the column 333a).

In this case, the employee may further view the same page of the pay statement for the month repeatedly (the viewing is recognized as the second time or more from the fact that then-current time is already stored in the column in question in the second sub-step). The third sub-step and the fourth sub-step are not executed for the second and subsequent viewings.

Thereafter, the first processing procedure is ended.

(Details of Step S401)

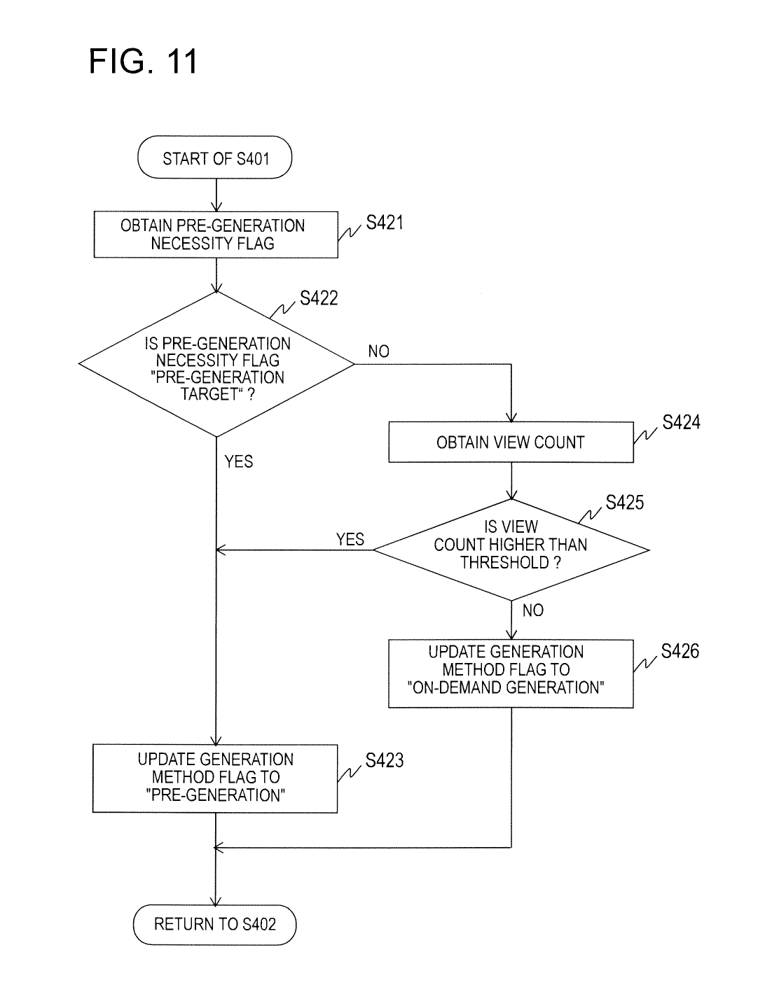

Details of Step S401 in the first processing procedure are described with reference to FIG. 11.

In Step S421, the generation method determining module 41 obtains the pre-generation necessity flag. Specifically, the generation method determining module 41 identifies an arbitrary combination of an employee number and a page number, and obtains the pre-generation necessity flag stored in a cell that corresponds to the identified combination from the pre-generation target table 22 (FIG. 4(a)).

In Step S422, the generation method determining module 41 determines whether or not the pre-generation necessity flag is “pre-generation target”. Specifically, the generation method determining module 41 proceeds to Step S423 when the pre-generation necessity flag obtained in Step S421 is “pre-generation target” (“YES” in Step S422), and proceeds to Step S424 otherwise (“NO” in Step S422).

In Step S423, the generation method determining module 41 updates the generation method flag to “pre-generation”. Specifically, the generation method determining module 41 updates the generation method flag to “pre-generation” in a cell of the generation method table 25 (FIG. 6(a)) where the employee number on the vertical axis that is a part of the combination identified in Step S421 intersects with the page number on the horizontal axis that is the other part of the identified combination.

In Step S424, the generation method determining module 41 obtains the view count. Specifically, the generation method determining module 41 obtains a view count from a cell of the view history table 23 (FIGS. 4(b) and 4(c)) where the employee number on the vertical axis that is a part of the combination identified in Step S421 intersects with the page number on the horizontal axis that is the other part of the identified combination. The generation method determining module 41 may instead obtain a view count from a cell where an “average” on the vertical axis intersects with the page number on the horizontal axis that is a part of the combination identified in Step S421.

In Step S425, the generation method determining module 41 determines whether or not the view count is higher than a threshold. Specifically, the generation method determining module 41 compares the view count obtained in Step S424 against a given threshold. The generation method determining module 41 proceeds to Step S423 when the view count is higher (“YES” in Step S425), and proceeds to Step S426 otherwise (“NO” in Step S425).

In Step S426, the generation method determining module 41 updates the generation method flag to “on-demand generation”. Specifically, the generation method determining module 41 updates the generation method flag to “on-demand generation” in a cell where the employee number on the vertical axis that is a part of the combination identified in Step S421 intersects with the page number on the horizontal axis that is the other part of the identified combination.

Steps S421 to S426 are repeated for every “arbitrary combination of an employee number and a page number”.

The procedure then returns to Step S402.

(Details of Step S402)

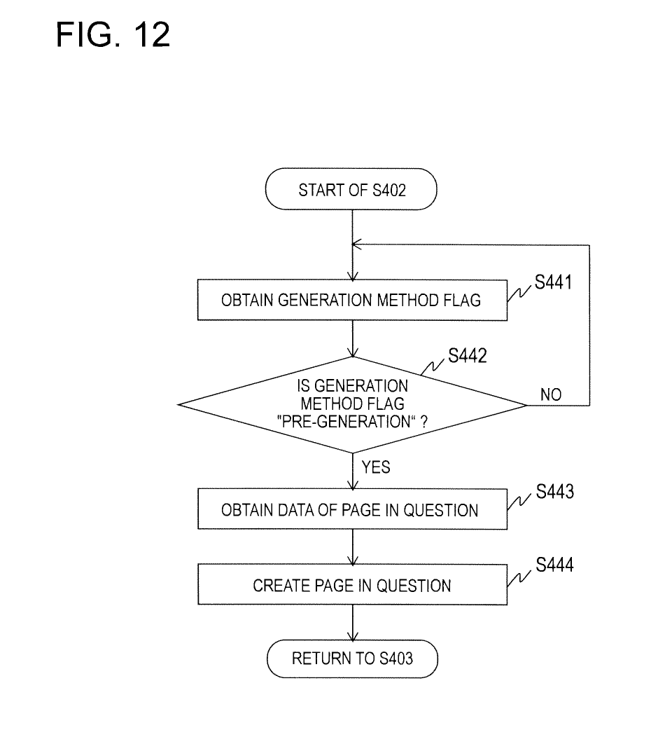

Details of Step S402 in the first processing procedure are described with reference to FIG. 12.

In Step S441, the pre-generation module 42 obtains the generation method flag. Specifically, the pre-generation module 42 identifies an arbitrary combination of an employee number and a page number, and obtains the generation method flag stored in a cell that corresponds to the identified combination from the generation method table 25 (FIG. 6(a)).

In Step S442, the pre-generation module 42 determines whether or not the generation method flag is “pre-generation”. Specifically, the pre-generation module 42 proceeds to Step S443 when the generation method flag obtained in Step S441 is “pre-generation” (“YES” in Step S442), and returns to Step S441 otherwise (“NO” in Step S442).

In Step S443, the pre-generation module 42 obtains data of the page in question. Specifically, the pre-generation module 42 executes a first sub-step to receive an input of a payment year/month which is entered by the administrator of the electronic distribution device 2 via the input device 14.

The pre-generation module 42 executes a second sub-step to obtain data of the page in question for the employee in question from the pre-generation data (FIG. 3), based on the employee number and page number of the combination identified in Step S441, and on the payment year/month received in the first sub-step.

In Step S444, the pre-generation module 42 generates the page in question. Specifically, the pre-generation module 42 generates the page in question that can be viewed on the output device 55 of the user terminal device 3 from the data obtained in Step S443. For instance, “page ⅓” of FIG. 7(a) is generated from the “pay statement page 1 data” 301 of FIG. 3(a).

Steps S441 to S444 are repeated for every “arbitrary combination of an employee number and a page number”.

Thereafter, the procedure returns to Step S403.

(Second Processing Procedure)

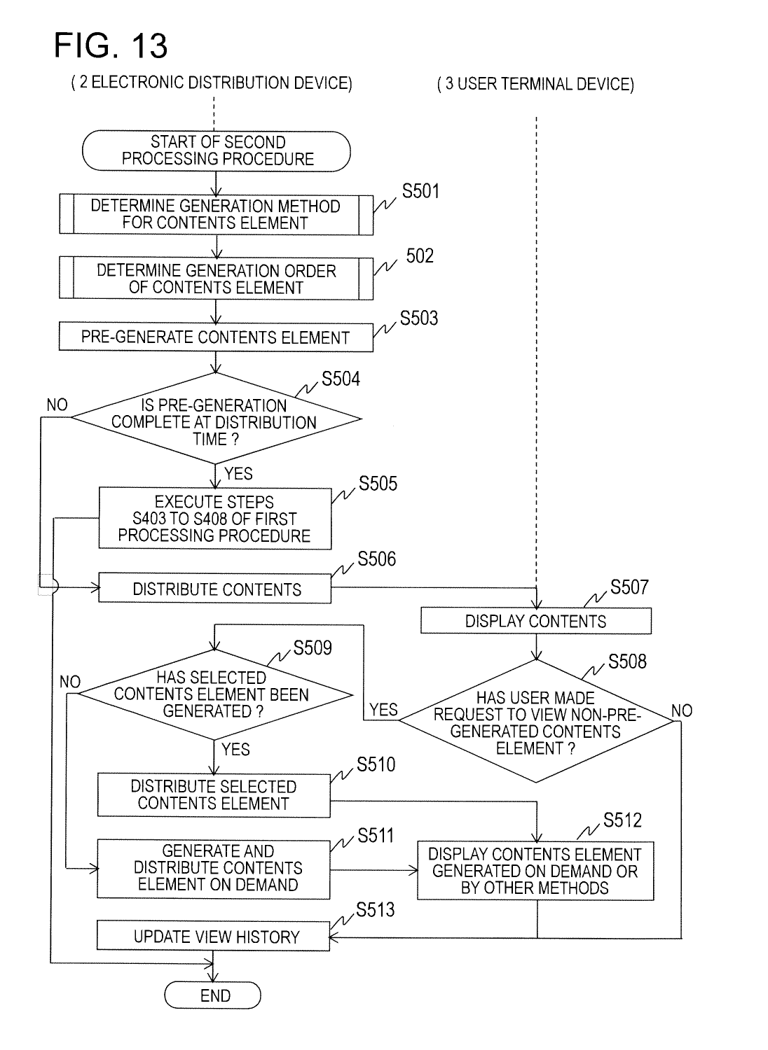

The second processing procedure is described with reference to FIG. 13.

In Step S501, the generation method determining module 41 determines the generation method for the contents element. This step is the same as “Step S401 of the first processing procedure”.

In Step S502, the generation order determining module 45 determines the generation order of contents elements. Specifically, the generation order determining module 45 creates the generation order table 26 (FIG. 6(b)) based on the viewed time table 24 (FIG. 5). Details of Step S502 are described later.

In Step S503, the pre-generation module 42 pre-generates contents elements. Specifically, the pre-generation module 42 executes a first sub-step to receive an input of a payment year/month which is entered by the administrator of the electronic distribution device 2 via the input device 14.

The pre-generation module 42 executes a second sub-step to obtain an employee number and a page number from the first record of the generation order table 26 (FIG. 6(b)).

The pre-generation module 42 executes a third sub-step to obtain data of the page in question for the employee in question from the pre-generation data 21 (FIG. 3), based on the employee number and page number obtained in the second sub-step, and on the payment year/month received in the first sub-step.

The pre-generation module 42 executes a fourth sub-step to generate the page in question that can be viewed on the output device 55 of the user terminal device 3 from the data obtained in the third sub-step.

The second to fourth sub-steps of Step S503 are repeated for every record of the generation order table 26 in ascending order of generation.

In Step S504, the pre-generation module 42 determines whether or not pre-generation is complete at the distribution time (this step is executed at the distribution time irrespective of whether Step S503 has been completed or not, and the execution of Step 503 continues after Step S504 is executed).

Specifically, the pre-generation module 42 proceeds to Step S505 when Step S503 is complete at the distribution time (“YES” in Step S504), and proceeds to Step S506 otherwise (“NO” in Step S504).

In Step S505, the pre-generation module 42, the screen displaying module 47, the on-demand generation module 43, and the view history updating module 44 execute Steps S403 to S408 of the first processing procedure. Thereafter, the second processing procedure is ended.

In Step S506, the pre-generation module 42 distributes contents. Specifically, the pre-generation module 42 distributes a pay statement that includes pre-generated pages and “blank” pages to the user terminal device 3. Of the distributed pay statement pages, a page whose generation method flag is “on-demand generation” and a page whose generation method flag is “pre-generation” but has not been generated in time for the arrival of the distribution time are “blank” pages which hold no information. A message such as “under construction” may be displayed on a “blank” page.

In Step S507, the screen displaying module 47 displays the contents. Specifically, the screen displaying module 47 displays the pay statement distributed in Step S506 on the output device 55 of the user terminal device 3 as illustrated in FIG. 8.

In Step S508, the screen displaying module 47 determines whether or not a request has been made to view a contents element that has not been pre-generated. Specifically, the screen displaying module 47 executes a first sub-step to receive, via the input device 54 of the user terminal device 3, an input of the page number of a page that the user who is an employee wishes to view. The user uses the input device 54 which includes a mouse or the like to select one of “1”, “2”, and “3” written in the “select page number” column of FIG. 8.

The screen displaying module 47 executes a second sub-step to store, in the main memory 12, temporarily, the current time in association with the selected page number and the employee number.

The screen displaying module 47 executes a third sub-step to determine whether or not the page of the selected page number is included in the pay statement distributed in Step S506. When the page is included (“NO” in Step S508), the screen displaying module 47 displays the page on the output device 55 of the user terminal device 3 and proceeds to Step S513. Otherwise (“YES” in Step S508), the screen displaying module 47 transmits the selected page number to the electronic distribution device 2, and proceeds to Step S509.

In Step S509, the pre-generation module 42 determines whether or not the selected contents element has been generated. Specifically, the pre-generation module 42 proceeds to Step S510 when the page of the page number received in Step S508 has been generated by the current time (not the distribution time) (“YES” in Step S509), and otherwise (“NO” in Step S509) proceeds to Step S511.

In Step S510, the pre-generation module 42 distributes the selected contents element. Specifically, the pre-generation module 42 distributes the selected page to the user terminal device 3.

In Step S511, the on-demand generation module 43 generates the contents element on demand and distributes the contents element. Specifically, the on-demand generation module 43 executes a first sub-step to obtain data of the page in question from the pre-generation data (FIG. 3) based on the page number received in Step S508, and to generate the page in question from the obtained data.

The on-demand generation module 43 executes a second sub-step to distribute the generated page to the user terminal device 3.

In Step S512, the screen displaying module 47 displays the contents element generated on demand or by other methods. Specifically, the screen displaying module 47 displays on the output device 55 of the user terminal device 3 a page generated by pre-generation at a point later than the distribution time, or the page generated in Step S511. For example, when the selected page number is “2”, page 2 is displayed as the top page as illustrated in FIG. 9.

In Step S513, the view history updating module 44 updates the view history. This step is the same as “Step S408 of the first processing procedure”.

The second processing procedure is then ended.

(Details of Step S502)

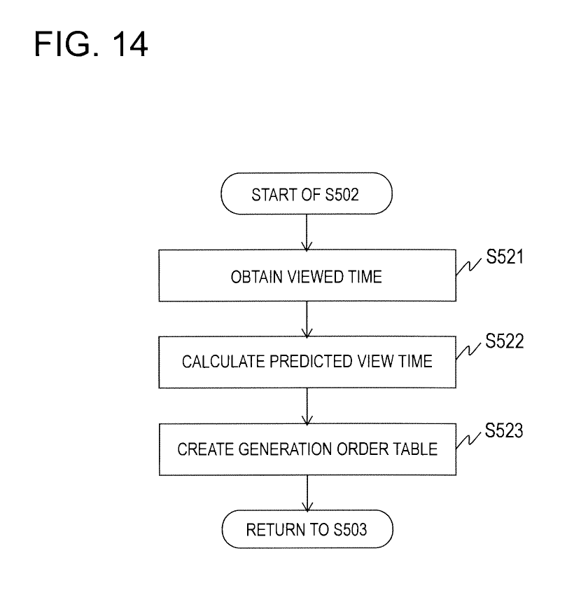

Details of Step S502 of the second processing procedure are described with reference to FIG. 14.

In Step S521, the generation order determining module 45 obtains viewed times. Specifically, the generation order determining module 45 identifies an arbitrary combination of an employee number and a page number to obtain, from the viewed time table 24 (FIGS. 5(a), 5(b), and 5(c)) of every month, every viewed time stored in a cell where the employee number on the vertical axis that is a part of the identified combination intersects with the page number on the horizontal axis that is the other part of the identified combination. For example, in the case where the identified combination is “0002 and page 1”, “2009/11/01 10:30” is obtained from the “2009/11 pay statement viewed time” 331, “2009/12/01 11:00” is obtained from the “2009/12 pay statement viewed time” 332, and “2010/01/01 11:30” is obtained from the “2010/01 pay statement viewed time” 333.

In Step S552, the generation order determining module 45 calculates a predicted view time. Specifically, the generation order determining module 45 executes a first sub-step to calculate for each month the length of time elapsed after distribution till viewing by subtracting the distribution time of the month from the viewed time of the month which has been obtained in Step S521. For example, in the case where the distribution time is 10:00 of 1st in every month, the length of time elapsed after distribution till the employee “0002” views “page 1” is calculated as “00:30” in November, 2009, “01:00” in December, 2009, and “01:30” in January, 2010.

The lengths of time elapsed after distribution till viewing in the respective months which are results of the calculation are averaged in a second sub-step executed by the generation order determining module 45. The average value in the example described above is (00:30+01:00+01:30)/3=“01:00”.

The generation method determining module 41 executes a third sub-step to add the calculated average value to the distribution time of a distribution occasion in question, thereby obtaining a predicted view time. When the distribution time of the distribution occasion in question is “2010/03/01 10:00”, the predicted view time in the example described above is “2010/03/01 11:00”.

Steps S521 and S522 are repeated for every arbitrary combination of an employee number and a page number. Therefore, at the time when Steps S521 and S522 are completed, as many predicted view times as a number obtained by multiplying the employee count by the page count have been calculated in association with the combinations of an employee number and a page number.

In the case where the viewed time has a value “unviewed” in a cell, the maximum viewed time of that month, for example, “2009/11/30 23:59”, is regarded as the value stored in the cell.

In Step S523, the generation order determining module 45 creates the generation order table 26 (FIG. 6(b)). Specifically, the generation order determining module 45 executes a first sub-step to create as many new records as a number obtained by multiplying the employee count by the page count in the generation order table 26.

The generation order determining module 45 executes a second sub-step to respectively store an employee number, a page number, and a predicted view time in the employee number column 352, page number column 353, and predicted view time column 354 of each new record in association with one another.

The generation order determining module 45 executes a third sub-step to sort all records of the generation order table 26 in chronological order of the predicted view times, and to store values “1”, “2”, “3” . . . in the generation order column 351 chronologically, starting the record that has the earliest predicted view time.

The procedure then returns to Step S503.

(Third Processing Procedure)

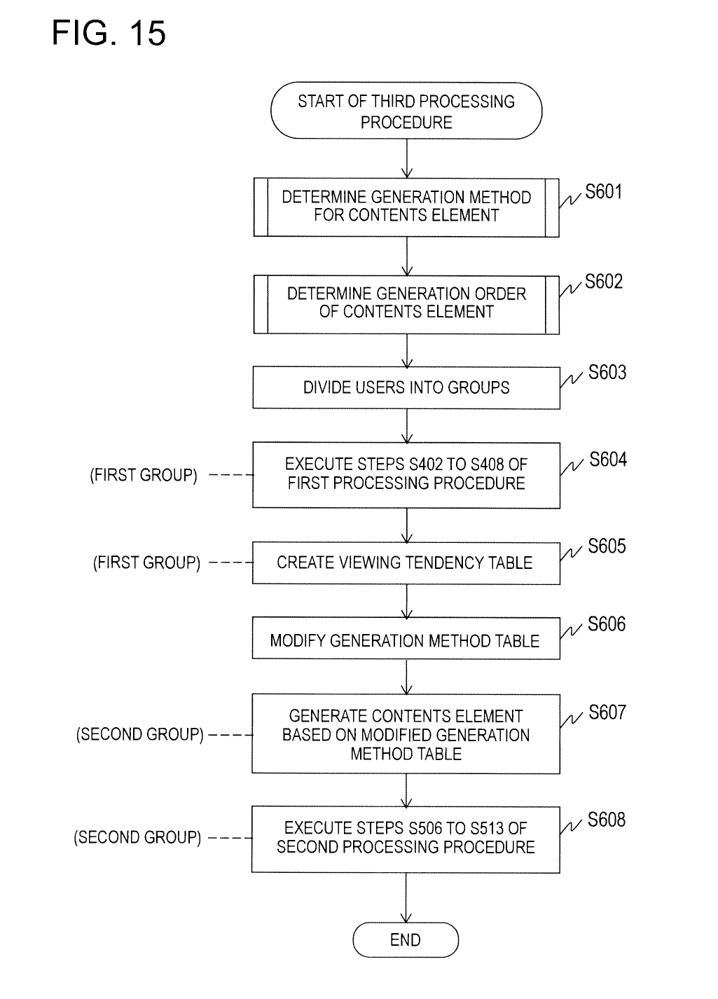

The third processing procedure is described with reference to FIG. 15.

In Step S601, the generation method determining module 41 determines the generation method for the contents element. This step is the same as “Step S401 of the first processing procedure”.

In Step S602, the generation order determining module 45 determines the generation order of contents elements. This step is the same as “Step S502 of the second processing procedure”.

In Step S603, the generation order determining module 45 divides users into groups. Specifically, the generation order determining module 45 executes a first sub-step to divide all records of the generation order table 26 into aggregations so that records of one aggregation share the same employee number.

The generation order determining module 45 executes a second sub-step to remove, from each aggregation, all records but the record that has the earliest predicted view time.

The generation order determining module 45 executes a third sub-step to divide the remaining records into a first group where each predicted view time is earlier than a given threshold and a second group for records that do not belong to the first group.

In Step S604, the pre-generation module 42, the screen displaying module 47, the on-demand generation module 43, and the view history updating module 44 execute Steps S402 to S408 of the first processing procedure for each employee number in the first group.

In Step S605, the viewing tendency reflecting module 46 creates the viewing tendency table 27 (FIG. 6(c)). Specifically, the viewing tendency reflecting module 46 executes a first sub-step to compare, for every cell (only in records holding employee numbers that belong to the first group), the view count of the view history table 23 at a point where a given length of time has elapsed after the distribution time (hereinafter may also be referred to as “post-distribution view history table”) and the view history table 23 immediately before the distribution time (hereinafter may also be referred to as “pre-distribution view history table”). The viewing tendency reflecting module 46 stores “viewed” in the cell in question in the post-distribution view history table when the view count of the post-distribution view history table is higher. The viewing tendency reflecting module 46 otherwise stores “unviewed” in the cell in question in the post-distribution view history table. The view history updating module 44 saves the pre-distribution view history table in the main memory 12 in Step S604.

The post-distribution view history table may be the view history table 23 at the time when a given percentage (e.g., 50%) of employees of the first group have finished viewing.

The viewing tendency reflecting module 46 executes a second sub-step to create a copy of the generation method table 25 (FIG. 6(a)), leaves records of the copy that hold employee numbers belonging to the first group, and deletes the rest of the records.

The viewing tendency reflecting module 46 executes a third sub-step to add “distributed” or “undistributed” that has been stored in the post-distribution view history table in the first sub-step to a cell in the copy of the generation method table 25 where the same employee number on the vertical axis intersects with the same page number on the horizontal axis, and to store the added value.

The viewing tendency reflecting module 46 executes a fourth sub-step to provide a user group column between the employee number column 341 and page 1 column 342 of the generation method table 25, and to store “1” in the user group column in each row. The copy of the generation table 25 is then used as the viewing tendency table 27 (FIG. 6(c)).

In Step S606, the viewing tendency reflecting module 46 modifies the generation method table 25 (FIG. 6(a)). Specifically, the viewing tendency reflecting module 46 executes a first sub-step to identify a page number for which the percentage of cells in the viewing tendency table 27 (FIG. 6(c)) that store “pre-generation and unviewed” exceeds a given threshold.

In the example of FIG. 6(c), there are only two records (the employees “0001” and “0002”). The number of records where “pre-generation and unviewed” is stored in the columns 363 to 365 is “0” for page 1, “0” for page 2, and “2” for page 3. The percentage of cells that store “pre-generation and unviewed” is “0/2=0%” for page 1, “0/2=0%” for page 2, and “2/2=100%” for page 3. If the given threshold is “50%”, only the percentage of the cells for page 3 exceeds the threshold. “Page 3” is identified in this case.

The viewing tendency reflecting module 46 executes a second sub-step to change the generation method flag to “on-demand generation” in each cell of the generation method table 25 where an employee number on the vertical axis intersects with the page number on the horizontal axis that has been identified in the first sub-step.

The viewing tendency reflecting module 46 executes a third sub-step to identify a page number for which the percentage of cells in the viewing tendency table 27 (FIG. 6(c)) that store “on-demand generation and viewed” exceeds a given threshold (the identification method used here is as described above).

The viewing tendency reflecting module 46 executes a fourth sub-step to change the generation method flag to “pre-generation” in each cell of the generation method table 25 where an employee number on the vertical axis intersects with the page number on the horizontal axis that has been identified in the third sub-step.

The viewing tendency reflecting module 46 may selectively execute only one of “the first and second sub-steps” and “the third and fourth sub-steps”. Whether to execute “the first and second sub-steps” and “the third and fourth sub-steps” may be determined based on execution cycles defined respectively for “the first and second sub-steps and the third and fourth sub-steps” in advance, for example, executing “the first and second sub-steps” every month whereas “the third and fourth sub-steps” are executed only once per year in a specific month.

In Step S607, the pre-generation module 42 generates contents elements based on the modified generation method table 25.

Specifically, the pre-generation module 42 executes the same processing as Step S402 of the first processing procedure for an employee number of the second group. However, the generation method table 25 used in this step is the one modified in Step S606.

In Step S608, the pre-generation module 42, the screen displaying module 47, the on-demand generation module 43, and the view history updating module 44 execute Steps S506 to S513 of the second processing procedure for an employee number of the second group.

The third processing procedure is then ended.

(Modified Example of the Third Processing Procedure)

In Step S603, the generation order determining module 45 uses one threshold to divide records (which correspond to employees) into two groups. The generation order determining module 45 may instead use n (n=2, 3 . . . ) thresholds to divide records into (n+1) groups. The grouping may use the generation order of records in addition to a threshold that indicates time. For example, records may be grouped so that “records whose places in generation order are the fifth place or higher are put in a first group, whereas records that are assigned a number greater than 5 and equal to or less than 10 as their places in generation order are put in a second group, and records that are assigned a number greater than 10 and equal to or less than 15 as their places in generation order are put in a third group”.

In Steps S604 to S608, the modules may repeat processing of modifying the generation method flag based on the view count after distribution to users of the n-th group, and distributing to users of the (n+1)-th group based on the modified generation method flag.

### Effects of this Embodiment

According to the first processing procedure, contents elements unlikely to be viewed after distributed can be identified on a user-by-user basis and on a contents element-by-contents element basis so that the generation of the identified contents elements is pushed back to a point later than the distribution time. According to the second processing procedure, even when not all of contents elements have been generated by the distribution time for some reason, contents elements that are highly likely to be viewed can be generated preferentially. According to the third processing procedure, the viewing tendency in a distribution occasion in question can be reflected at an early stage. The third processing procedure is therefore effective for cases where there is a contents element that is included among distributed contents elements for the first time in one distribution occasion and predicting the viewing tendency from past view counts or the like is not possible with regard to this element.

This invention is not limited to the embodiment described above, and can be carried out in a modified mode without departing from the spirit of this invention.

For instance, the first to third processing procedures described above and the modified example thereof deal with an example in which contents (elements) that are not pre-generated and distributed are generated and distributed with a viewing request from the user as a trigger (on demand). Alternatively, contents that are not pre-generated may be generated dynamically, without waiting for a viewing request from the user, to be distributed when a viewing request from the user triggers the distribution. This procedure has an effect in that contents are distributed quickly after the user makes a viewing request, and can be a particularly effective procedure for cases where the data amount of contents that are not pre-generated is large.

Contents that are not pre-generated may further be generated dynamically, or generated and distributed dynamically, without the user ever making a viewing request. This procedure has an effect in that the whole contents are distributed while lessening the temporal concentration of processing load on the electronic distribution device 2 which handles the generation and distribution of contents. The procedure can be particularly effective for cases where distributing the whole contents to each user is obligatory.

The programs that implement various functions in this embodiment can be stored in various recording media including magnetic media such as magnetic tapes and floppy disks (trademark), optical recording media such as compact disks (CDs) and digital versatile disks (DVDs), magneto-optical recording media such as magneto-optical disks (MOs), and semiconductor recording media. It is to be understood that the programs can be downloaded via a communication network such as the Internet as well.

### DESCRIPTION OF THE REFERENCE SIGNS

1 electronic distribution system
2 electronic distribution device
3 user terminal device
4 network
11, 51 central controller
12, 52 main memory
13, 53 auxiliary storage
14, 54 input device
15, 55 output device
16, 56 communication I/F
21 pre-generation data
22 pre-generation target table
23 view history table
24 viewed time table
25 generation method table
26 generation order table
27 viewing tendency table
41 generation method determining module
42 pre-generation module
43 on-demand generation module
44 view history updating module
45 generation order determining module
46 viewing tendency reflecting module
47 screen displaying module

What is claimed is:

1. An electronic distribution method using an electronic distribution device which repeatedly distributes contents including a plurality of contents elements at a predetermined distribution time to user terminal devices used by users of the contents, the electronic distribution method comprising:
storing, by storage of the electronic distribution device, view history information which stores, for each of the plurality of contents elements and for each of the users, a view count indicating how many times the each of the users has viewed the contents;
determining, by a controller of the electronic distribution device, a combination of one of the plurality of contents elements that can be distributed past the predetermined distribution time and one of the users based on the view counts of the view history information; and
generating and distributing, by the controller of the electronic distribution device, the contents element of the determined combination to a user terminal device that is used by the user of the determined combination, at a point that is after the predetermined distribution time and after a request to view the contents element of the determined combination is received from the user terminal device.

2. An electronic distribution method using an electronic distribution device which repeatedly distributes contents including a plurality of contents elements at a predetermined distribution time to user terminal devices used by users of the contents, the electronic distribution method comprising:
storing, by storage of the electronic distribution device, viewed time information which stores, for each of the plurality of contents elements and for each of the users, a viewed time indicating a time when the each of the users viewed the contents;
determining, by a controller of the electronic distribution device, an order of combinations each consisting of one of the plurality of contents elements that is to be generated and one of the users to which the one of the plurality of contents elements is to be distributed, based on the viewed times of the viewed time information;
generating, by the controller of the electronic distribution device, the contents elements of the combinations in the order and distributing contents elements whose generation is complete at the predetermined distribution time to user terminal devices used by the users of the combinations at the predetermined distribution time; and
generating and distributing, by the controller of the electronic distribution device, contents elements whose generation is not complete at the predetermined distribution time to the user terminal devices used by the users of the combinations after requests to view the contents elements are received from the user terminal devices used by the users of the combinations after the predetermined distribution time.

3. An electronic distribution method using an electronic distribution device which repeatedly distributes contents including a plurality of contents elements at a predetermined distribution time to user terminal devices used by users of the contents, the electronic distribution method comprising:
storing, by storage of the electronic distribution device, view history information which stores, for each of the plurality of contents elements and for each of the users, a view count indicating how many times the each of the users has viewed the contents;
storing, by the storage of the electronic distribution device, viewed time information which stores, for each of the plurality of contents elements and for each of the users, a viewed time indicating a time when the each of the users viewed the contents;
referring, by a controller of the electronic distribution device, to the viewed time information to identify, based on the viewed times, a group of users who are to be monitored for the view count;
distributing, by the controller of the electronic distribution device, the contents to user terminal devices used by the users belonging to the identified group, comparing the view count before and after the distribution of the contents for each of the users belonging to the group, and determining contents elements that are found out through the comparison to be unviewed after the predetermined distribution time; and
removing, by the controller of the electronic distribution device, the determined contents elements from contents elements to be distributed to user terminal devices that are used by users who do not belong to the group.

4. An electronic distribution device for repeatedly distributing contents including a plurality of contents elements at a predetermined distribution time to user terminal devices used by users of the contents, the electronic distribution device comprising:
storage for storing view history information which stores, for each of the plurality of contents elements and for each of the users, a view count indicating how many times the each of the users has viewed the contents; and
a controller configured to:
determine a combination of one of the plurality of contents elements that can be distributed past the predetermined distribution time and one of the users based on the view count of the view history information; and
generate and distribute the contents element of the determined combination to a user terminal device used by the user of the determined combination, at a point that is after the predetermined distribution time and after a request to view the contents element is received from the user terminal device.

5. An electronic distribution device for repeatedly distributing contents including a plurality of contents elements at a predetermined distribution time to user terminal devices used by users of the contents, the electronic distribution device comprising:
storage for storing viewed time information which stores, for each of the plurality of contents elements and for each of the users, a viewed time indicating a time when the each of the users viewed the contents; and
a controller configured to:
determine an order of combinations each consisting of one of the plurality of contents elements that is to be generated and one of the users to which the one of the plurality of contents elements is to be distributed, based on the viewed times of the viewed time information;
generate the contents elements of the combinations in the order and distribute contents elements whose generation is complete at the predetermined distribution time to user terminal devices used by the users of the combinations at the predetermined distribution time; and
generate and distribute contents elements whose generation is not complete at the predetermined distribution time to the user terminal devices used by the users of the combinations after requests to view the contents elements are received from the user terminal devices used by the users of the combinations after the predetermined distribution time.

6. An electronic distribution device for repeatedly distributing contents including a plurality of contents elements at a predetermined distribution time to user terminal devices used by users of the contents, the electronic distribution device comprising:
storage for storing:
view history information which stores, for each of the plurality of contents elements and for each of the users, a view count indicating how many times the each of the users has viewed the contents; and
viewed time information which stores, for each of the plurality of contents elements and for each of the users, a viewed time indicating a time when the each of the users viewed the contents; and
a controller configured to:
refer to the viewed time information to identify, based on the viewed times, a group of users who are to be monitored for the view count;
distribute the contents to user terminal devices used by the users belonging to the identified group, compare the view count before and after the distribution of the contents for each of the users belonging to the group, and determine contents elements that are found out through the comparison to be unviewed after the predetermined distribution time; and
remove the determined contents elements from contents elements to be distributed to user terminal devices used by users who do not belong to the group.

7. An electronic distribution program which causes an electronic distribution device to repeatedly distribute contents including a plurality of contents elements at a predetermined distribution time to user terminal devices used by users of the contents, the electronic distribution program configured to:
cause storage of the electronic distribution device to store view history information which stores, for each of the plurality of contents elements and for each of the users, a view count indicating how many times the each of the users has viewed the contents;
cause a controller of the electronic distribution device to determine a combination of one of the plurality of contents elements that can be distributed past the predetermined distribution time and one of the users based on the view counts of the view history information; and
cause the controller of the electronic distribution device to generate and distribute the contents element of the determined combination to a user terminal device used by the user of the determined combination, at a point that is after the predetermined distribution time and after a request to view the contents element is received from the user terminal device.

8. An electronic distribution program which causes an electronic distribution device to repeatedly distribute contents including a plurality of contents elements at a predetermined distribution time to user terminal devices used by users of the contents, the electronic distribution program configured to:
cause storage of the electronic distribution device to store viewed time information which stores, for each of the plurality of contents elements and for each of the users, a viewed time indicating a time when the each of the users viewed the contents;
cause a controller of the electronic distribution device to determine an order of combinations each consisting of one of the plurality of contents elements that is to be generated and one of the users to which the one of the plurality of contents elements is to be distributed, based on the viewed times of the viewed time information;
cause the controller of the electronic distribution device to generate the contents elements of the combinations in the order and distribute contents elements whose generation is complete at the predetermined distribution time to user terminal devices used by the users of the combinations at the predetermined distribution time; and
cause the controller of the electronic distribution device to generate and distribute contents elements whose generation is not complete at the predetermined distribution time to the user terminal devices used by the users of the combinations after requests to view the contents elements are received from the user terminal devices used by the users of the combinations after the predetermined distribution time.

9. An electronic distribution program which causes an electronic distribution device to repeatedly distribute contents including a plurality of contents elements at a predetermined distribution time to user terminal devices used by users of the contents, the electronic distribution program configured to:
cause storage of the electronic distribution device to store view history information which stores, for each of the plurality of contents elements and for each of the users, a view count indicating how many times the each of the users has viewed the contents;
cause the storage of the electronic distribution device to store viewed time information which stores, for each of the plurality of contents elements and for each of the users, a viewed time indicating a time when the each of the users viewed the contents;
cause a controller of the electronic distribution device to refer to the viewed time information to identify, based on the viewed times, a group of users who are to be monitored for the view count;
cause the controller of the electronic distribution device to distribute the contents to user terminal devices used by the users belonging to the identified group, compare the view count before and after the distribution of the contents for each of the users belonging to the group, and determine contents elements that are found out through the comparison to be unviewed after the predetermined distribution time; and
cause the controller of the electronic distribution device to remove the determined contents elements from contents elements to be distributed to user terminal devices used by users who do not belong to the group.
